(19) United States
(12) Patent Application Publication
(10) Pub. No.: US 2005/0164554 A1
(43) Pub. Date: Jul. 28, 2005

(54) Lance with multiple movement dispenser nozzle for high pressure cleaning equipments

(75) Inventors: Giovanni Cattaneo, Mozzo (IT); Gianni Padrin, Gallarate (IT)

Correspondence Address: YOUNG & THOMPSON, 745 SOUTH 23RD STREET, 2ND FLOOR, ARLINGTON, VA, 22202, US

(73) Assignee: INTERPUMP CLEANING S.P.A. - DIV. FAIP, VAIANO CREMASCO (IT)

(21) Appl. No.: 11/023,408

(22) Filed: Dec. 29, 2004

(30) Foreign Application Priority Data
Jan. 23, 2004 (IT) MI2004A000094

(51) Int. Cl. H01R 13/40

(52) U.S. Cl. 439/595

(57) ABSTRACT

A lance (10) with multiple movement dispenser nozzle (44) includes a tubular body (12) provided with an axial duct (20) for the passage of the pressure water fluid; a shaped sleeve (14) matched at the front end of the tubular body (12); a rotor or rotating element (16) housed into the shaped sleeve (14), and a plate-shaped element (18) supported by a plate (22) associated to the duct (20). On the front part facing the rotor (16), the plate-shaped element (18) is provided with a shaped central recess 26 which circularly extends and having an undulated external profile from which a plurality of additional recesses (32) radially extend. The opposite rear part of the plate-shaped element (18) is provided with an integral tang (24) engaging with the plate (22).

The present invention refers to a lance with multiple movement dispenser nozzle for high pressure cleaning equipments.

More particularly, the present invention refers to a lance for high pressure cleaning equipments with a nozzle which, connected to a support, is activated by the pressure fluid and continuously moves according to a rotating-oscillating movement.

It is known that the high pressure cleaning equipments, generally called hydrocleaners which are used both for professional and hobby purposes, typically comprise a plurality of interchangeable fittings in order to obtain different water jet deliveries. An inlet duct and an outlet one for the fluid, which is generally water with the addition of detergent, degreasing and/or polishing substances which are taken from one or more containers, are respectively connected to the cleaning equipment. On the free end of the outlet duct, which is conventionally a flexible tube, a conventional device for the alternate connection to the various lances or delivery guns is placed. Therefore, the outlet water jet can be more or less concentrated, or blade-oriented according to the various nozzles integrated into the lances. One of the known lances allows delivering the pressure fluid according to a rotating direction, thus allowing a cleaning with a turbine jet and avoiding the concentration in one place. In order to carry out this embodiment of the outlet jet, the dispenser nozzle integrated into the lance is connected in a misaligned way to a support which is rotated by the same water pressure.

According to this embodiment, said rotating support is provided with a plurality of pass-through holes requiring complex workings. This is mainly due to the fact that these holes need accurate dimensions and directions in such a way that the passage of the pressure fluid causes the rotation of the same support and, therefore, the one of the nozzle connected to it.

In addition to this drawback, in the known solutions the water delivery takes place with a constant rotating direction and, therefore, it is impossible to give the outlet fluid further and different directions. Instead a lance with a nozzle rotating and radially moving in order to increase the operating range of the pressure fluid jet would be advantageous.

Object of the present invention is to solve the above-mentioned drawbacks.

More particularly, object of the present invention is to provide a lance for high pressure cleaning equipments or hydrocleaners provided with a nozzle whose rotating support be obtained with simple workings and without making gauged drillings.

A further object of the invention is to provide of a lance as defined above wherein the dispenser nozzle, under the effect of the pressure fluid acting on the relevant support, is also radially moved during its rotation, thus increasing the operating range of the pressure water fluid.

A further object of the invention is to provide the users with a lance provided with a multiple movement dispenser nozzle for high pressure cleaning equipments assuring a high resistance level and reliability in time, which can be also easily manufactured and at low cost.

According to the present invention, these and other purposes are achieved by the lance with multiple movement dispenser nozzle comprising: a tubular body provided with an axial duct for the passage of the pressure fluid, a shaped sleeve matched at the front end of said tubular body, a rotor or rotating element housed into said shaped sleeve and a plate-shaped element supported by a plate associated to the duct, wherein the plate-shaped element, on the front part facing the rotor, is provided with a central recess, which circularly extends and with an external undulated profile from which a plurality of additional recesses radially extend, and, on the opposite rear part, with an integral tang engaging with said plate.

The tubular body can be made of stiff plastic material.

The manufacturing and functional features of the lance with multiple movement dispenser nozzle of the present invention can be better understood from the detailed description which follows wherein reference is made to the Figures of the attached table representing an embodiment given only by way of preferred non-limitative embodiment, wherein:

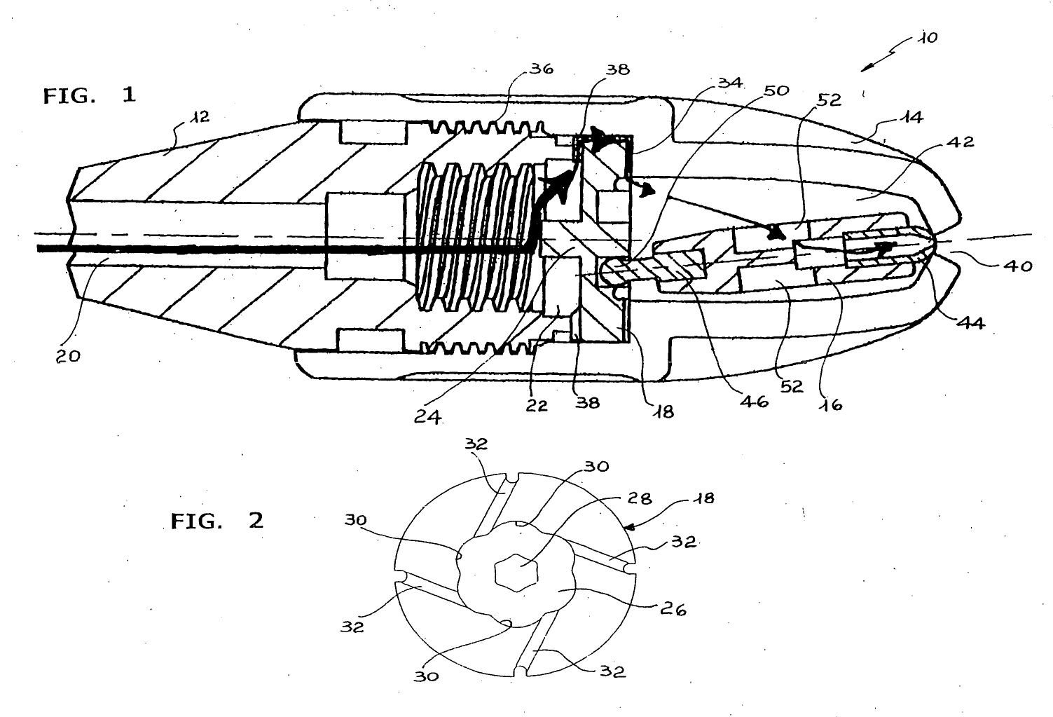

FIG. 1 shows a schematic partially sectioned side view of the lance with multiple movement dispenser nozzle of the present invention;

FIG. 2 shows a schematic plan view of the support of the nozzle of FIG. 1 on the front part facing the delivery area of the pressure fluid.

With reference to the above-mentioned Figures, the lance with multiple movement dispenser nozzle of the present invention, marked in its whole with 10 in FIG. 1, basically comprises: a tubular body 12, preferably made of stiff plastic material making the same lance (represented only in its front end for easiness); a shaped sleeve 14 connected to said front end of the tubular body 12; a rotor or rotating element 16 housed into said shaped sleeve 14, and a plate-shaped element 18 placed into said front end of the tubular body 12; the rotor 16 engaging into said plate-shaped element 18.

The tubular body 12 is provided with an axial duct 20 of the pressurized fluid coming out of the hydrocleaner which is conveyed towards the front end facing the rotor 16 of the same tubular body 12. In this position the duct 20 radially extends into a plate 22 making the support means of the plate-shaped element 18.

Said plate-shaped element 18 schematized in detail in FIG. 2, in its front part facing the rotor 16, consists in a circular-based plate which, on the opposite part facing the plate 22, is provided, in its central part, with an integral tang 24 with a circular section engaging with the same plate 22 being accordingly drilled.

In its front part facing the rotor 16, the plate-shaped element 18 is provided with a shaped recess 26 which is formed centrally and around a hub 28 making the axial extension of the tang 24. Said shaped recess 26 is circularly extended and defines an undulated external profile formed by a plurality of curved-concave adjacent sectors 30 which are jointed among them by a wide ray.

In a preferred and non-critical embodiment, even the external part of the hub 28 is basically undulated and defines a substantially hexagonal profile: wherein sides develop with a slight recess and joint among them with a limited ray.

From the external part of the shaped recess 26, a plurality of additional recesses 32 radially extend in the shape of channels reaching the edge of the plate-shaped element 18.

According to a preferred embodiment shown in FIG. 2, said recesses 32 are four, orthogonally directed each other and show a substantially semicircular profile.

In its front part facing the rotor 16, said plate-shaped element 18 is delimited by the shaped sleeve 14, which is known in itself and defines a shoulder 34 and is fastened by thread 36 or equivalent fastening means to the tubular body 12. The diameter of the plate-shaped element 18 is slightly lower than the one of the seat of the sleeve 14 defined by the shoulder 34 in such a way that the fluid coming from the duct 20 can externally step over the same plate-shaped element 18 and get into the sleeve 14 following the path marked by the arrow in FIG. 1. The passage of the fluid is possible because the plate 22 is provided with one or more radial openings 38, preferably four radial openings placed at 90°.

The sleeve 14 is provided with an end opening 40 which is preferably flared and defines a substantially truncated-conical recess 42 within which the rotor 16 is placed. Said rotor 16 which is substantially known in itself, is provided at its front end with a nozzle 44 having a semicircular profile matching the hole 40; while to the opposite rear end said rotor 16 is associated to a toe 46 projecting from said end towards the plate-shaped element 18 with which it engages. In particular, the free end of the toe 46 projecting from the nozzle 16 is made by a substantially hemispherical head 50 placing into the shaped recess 26 of the plate-shaped element 18. The toe 46 can be integrally obtained with the nozzle 16, or according to the preferred embodiment of FIG. 1, can be constituted by an independent element fastened to the same nozzle with any suitable fastening means such as adhesive means. The plate-shaped element 18 and the shoulder 34 are in contact; the passage of the fluid is allowed by the radial recesses 32 which are present on the plate-shaped element 18. After having reached the recess 42 of the mentioned sleeve, this fluid gets into the rotor 16 through conventional radial openings 52 obtained on it and conveys into the nozzle 44 from which it comes out.

According to the structure of the lance of the present invention, the fluid comes out not only according to a rotating path given by the rotor 16 engaged with the plate-shaped element 18, but also with a simultaneous oscillating movement due to the fact that the head 50 of the toe 46 matches the undulated external profile of the recess 26 of the same plate-shaped element 18. The undulated profile of the hub 28 defines the set path achieved by the toe 46 with its movement; in this way the movement is not only rotating but also rotating and oscillating at the same time. The pressure fluid coming from the duct 20 goes out through the openings 38 of the plate 22 and, passing outside the plate-shaped element 18, it reaches the front part of it upon which the recesses 32 in the shape of channels are obtained. The fluid matching and placing into said recesses 32 makes the plate-shaped element 18 rotate and therefore the rotor 16 associated to its front part through the toe 46.

As can be seen, the advantages obtained by the invention are clear.

In the lance of the present invention the dispenser nozzle 44 shoots a water jet which directs both circularly and by continuous oscillation, thus increasing the cleaning effect.

The embodiment of the plate-shaped element 18 is particularly advantageous, it does not foresee the presence of pass-through holes to convey the pressure fluid towards said nozzle.

Even though the present invention has been described above with reference to one embodiment which is given only by way of non-limitative example, many changes and variants will be clear to a technician according to the above-mentioned description.

Therefore the present invention means to include all changes and variants falling within the spirit and the protective scope of the following claims.

1. A lance (10) with multiple movement dispenser nozzle (44) comprising:
a tubular body (12) provided with an axial duct (20) for the passage of the pressure fluid;
a shaped sleeve (14) matched at the front end of said tubular body (12);
a rotor or rotating element (16) housed into said shaped sleeve (14), and
a plate-shaped element (18) supported by a plate (22) associated to the duct (20), characterized in that on the front part facing the rotor (16) the plate-shaped element (18) is provided with a shaped central recess (26) which circularly extends and has an undulated external profile from which a plurality of additional recesses (32) radially extend and, on the opposite rear part, with an integral tang (24) engaging with said plate (22).

2. The lance according to claim 1, characterized in that said plate-shaped element (18) consists in a circular-based plate placed on the free front end of the tubular body (12) and delimited by the a shoulder (34) of the shaped sleeve (14), on the part facing the rotor (16).

3. The lance according to claim 1, characterized in that the shaped recess (26) is obtained around a hub (28) making the extension of the tang (24); the undulated external profile of said recess (26) being formed by a plurality of adjacent sectors (30) with a curved-concave development jointed by a wide radius among them.

4. The lance according to claim 1, characterized in that the recesses (32) of the plate-shaped element (18) extend from the external part of the shaped recess (26) in the shape of channels reaching the end of said plate-shaped element (18), and show a substantially semicircular profile.

5. The lance according to claim 1, characterized in that said recesses (32) are four and orthogonally directed each other.

6. The lance according to claim 1, characterized in that the tang (24) of the plate-shaped element (18) has a circular section.

7. The lance according to claim 3, characterized in that the hub (28) has substantially hexagonal profile, with slightly concave sides jointed by a narrow radius.

8. The lance according to claim 1, characterized in that the plate (22) is provided with one or more radial openings (38).

9. The lance according to claim 1, characterized in that the diameter of the plate-shaped element (18) is lower than the one of the seat of the sleeve (14) defined by the shoulder (34).

10. The lance according to claim 1, characterized in that the sleeve (14) is fastened to the tubular body (12) by thread (36), is provided with an end opening (40) and defines a substantially truncate-conical recess (42) wherein the rotor (16) is housed, the latter being provided with radial openings (52) and associated to a toe (46) at the rear end facing the plate-shaped element (18), free end of said toe (46) is constituted by a substantially hemispherical head (50) placing into said shaped recess (26).
